(19) United States
(12) Patent Application Publication
(10) Pub. No.: US 2021/0365564 A1
(43) Pub. Date: Nov. 25, 2021

(54) TECHNIQUES FOR MONITORING COMPUTING INFRASTRUCTURE

(71) Applicant: DISNEY ENTERPRISES, INC., Burbank, CA (US)

(72) Inventors: Bashar H. M. EWAIDA, Sherman Oaks, CA (US); Gregory J. NAVARRO, San Marino, CA (US)

(21) Appl. No.: 16/882,221

(22) Filed: May 22, 2020

(51) Int. Cl. G06F 21/57; G06F 11/30; G06F 11/34; G06N 5/04; G06N 20/00

(52) U.S. Cl. CPC G06F 21/577; G06F 11/3006; G06F 2221/034; G06N 5/04; G06N 20/00; G06F 11/3495

(57) ABSTRACT

A technique for monitoring a computing infrastructure having one or more target devices includes receiving, from a plurality of evaluation services, evaluation results of one or more target devices. The technique further includes extracting, using a different data collector for each of the plurality of evaluation services, data from each of the evaluation results. The technique further includes converting the extracted data to a common format, determining whether an issue or a vulnerability is present in the one or more target devices based on the extracted and converted data, and reporting the issue or the vulnerability.

### BACKGROUND

### Field of the Invention

The various embodiments relate generally to management of computing devices and, more particularly, to techniques for monitoring computing infrastructure.

### Description of the Related Art

Network connected computing devices, including devices providing content and/or services for other computing devices over networks, such as the Internet, are often subject to attack by hackers, malware, and/or the like. For example, one common form of attack is based on port scanning. In a port scanning attack, a port scanning toolkit is used to systematically scan each of the network ports at a target IP address to determine which ports have a service that is open and listening on the port. Once a port is determined to be open, malware tools are used to initiate various attacks on the listening service to see if the listening service is susceptible to any vulnerability that may be used to gain unauthorized access to the computing device.

To help safeguard against these and other types of attacks, the information technology (IT) team of the owner of a computing system typically employs a number of evaluation tools to scan and assess each of the computing devices to determine which of the computing devices, if any, have issues and/or vulnerabilities that may require attention by the IT team so as to further safeguard and/or improve the reliability of the computing devices. Once one or more issues and/or vulnerabilities are detected, the IT team can follow up by making changes to the computing devices (e.g., closing unnecessarily open ports), installing patches and/or security updates, performing maintenance, and/or the like to eliminate the one or more issues and/or vulnerabilities. Further, the IT team may use the evaluation tools regularly to assess software updates on the computing device, assess the computing devices for newly discovered issues and/or vulnerabilities, and/or the like.

For an enterprise with a limited number of computing devices, performing systematic evaluation of each of the computing devices can often be managed by simply maintaining a list of known computing devices of the enterprise and scheduling regular evaluations of the computing devices. This approach, however, does not scale well when the enterprise has a large number of computing devices, computing devices spread across a large network, computing devices hosted by cloud service providers, and/or the like. For example, each of the evaluation tools typically provides information on a limited number of issues and/or vulnerabilities. In addition, each of the evaluation tools may provide misleading information regarding the existence of issues and/or vulnerabilities (e.g., false positive detection of issues and/or vulnerabilities) and/or different evaluation tools may provide conflicting results as to whether an issue and/or vulnerability exists.

As the foregoing illustrates, what is needed in the art are more effective approaches for monitoring and evaluating the computing devices forming a computing infrastructure.

### SUMMARY

One embodiment disclosed herein sets forth a computer-implemented method for monitoring a computing infrastructure having one or more target devices. The method includes receiving, from a plurality of evaluation services, evaluation results of one or more target devices. The method further includes extracting, using a different data collector for each of the plurality of evaluation services, data from each of the evaluation results. The method further includes converting the extracted data to a common format, determining whether an issue or a vulnerability is present in the one or more target devices based on the extracted and converted data, and reporting the issue or the vulnerability.

Further embodiments provide, among other things, one or more non-transitory computer-readable storage media and a computing device configured to implement the method set forth above.

At least one technical advantage of the disclosed techniques relative to the prior art is that the disclosed techniques provide automated mechanisms to integrate and consolidate the evaluation results of multiple computing devices received from multiple evaluation tools that each provide evaluation results in different formats. In addition, the disclosed techniques allow the evaluation results of the multiple evaluation tools to be presented in a unified manner. Further, the disclosed techniques also provide improved ways of validating whether one or more issues and/or vulnerabilities identified by one or more of the evaluation tools are actually present in a target device so as to reduce or eliminate costly and/or time consuming maintenance and/or updates to the target device for which the one or more issues and/or vulnerabilities are not actually present. Finally, the disclosed techniques further provide automated mechanisms for prescreening target devices before attempting to validate the presence of issues and/or vulnerabilities. The prescreening identifies target devices that have a high risk of downtime or other failures that may result from performing a validation so that unnecessary downtime of the target devices is reduced and/or avoided

These technical advantages provide one or more technological advancements over prior art approaches.

### BRIEF DESCRIPTION OF THE DRAWINGS

So that the manner in which the above recited features of the various embodiments can be understood in detail, a more particular description of the various embodiments, briefly summarized above, may be had by reference to embodiments, some of which are illustrated in the appended drawings. It is to be noted, however, that the appended drawings illustrate only typical embodiments of the inventive concepts and are therefore not to be considered limiting of its scope, for the invention may admit to other equally effective embodiments.

FIG. 1 illustrates a computing system configured to implement one or more aspects of the various embodiments;

FIG. 2 is a more detailed illustration of the security module of FIG. 1 to implement one or more aspects of the various embodiments;

FIG. 3 illustrates an example user interface for the security module of FIGS. 1 and 2 to implement one or more aspects of the various embodiments; and

FIG. 4 sets forth a flow diagram of method steps for monitoring computing devices for issues and/or vulnerabilities to implement one or more aspects of the various embodiments.

### DETAILED DESCRIPTION

In the following description, numerous specific details are set forth to provide a more thorough understanding of the embodiments of the present invention. However, it will be apparent to one of skill in the art that the embodiments of the present invention may be practiced without one or more of these specific details.

### System Overview

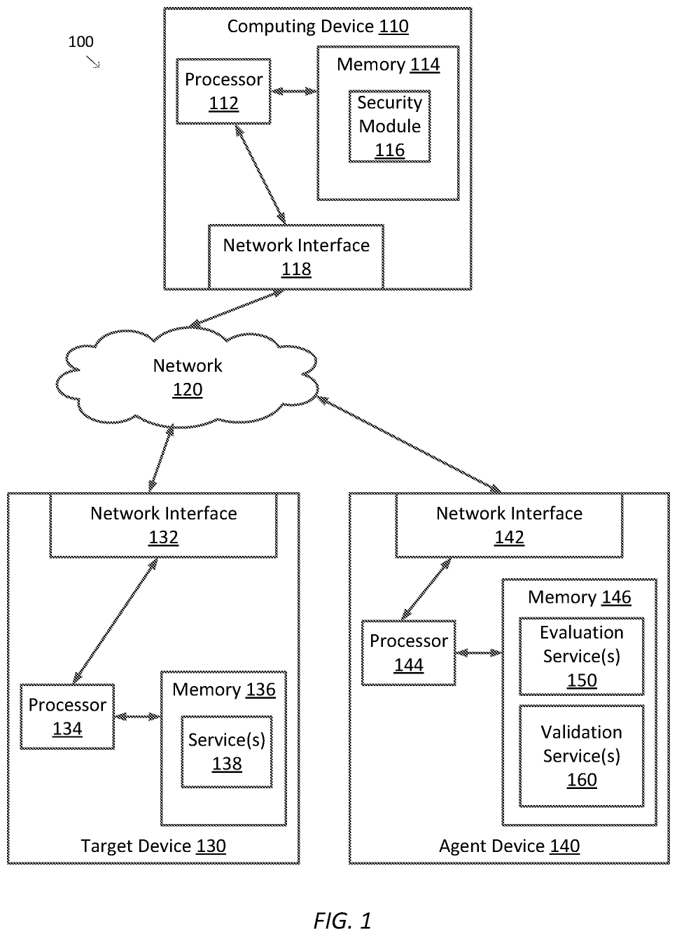

FIG. 1 illustrates a computing system 100 configured to implement one or more aspects of the various embodiments. As shown in FIG. 1, computing system 100 includes a computing device 110. Computing device 110 includes a processor 112 coupled to memory 114. Operation of computing device 110 is controlled by processor 112. And although computing device 110 is shown with only one processor 112, it is understood that processor 112 may be representative of one or more central processing units, multi-core processors, microprocessors, microcontrollers, digital signal processors (DSPs), field programmable gate arrays (FPGAs), application specific integrated circuits (ASICs), graphics processing units (CPUs), tensor processing units (TPUs), and/or the like in computing device 110. Computing device 110 may be implemented as a stand-alone subsystem such as a server, as a board added to another computing device, and/or as a virtual machine.

Memory 114 may be used to store software executed by computing device 110 and/or one or more data structures used during operation of computing device 110. Memory 114 may include one or more types of computer-readable storage media. Some common forms of computer-readable storage media may include floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, and/or any other medium from which a processor or computer is adapted to read.

As shown, memory 114 includes a security module 116 that is responsible for controlling one or more aspects of the operation of computing device 110, including, for example, the monitoring of a computing infrastructure, which may include the management of scans for issues and/or vulnerabilities for one or more target devices (e.g., a target device 130) as is described in further detail below. And although security module 116 is characterized as a software module, security module 116 may be implemented using software, hardware, and/or a combination of hardware and software.

In order to support the monitoring of the computing infrastructure and the scanning of the one or more target devices 130 for issues and/or vulnerabilities, computing device 110 includes a network interface 118 coupling computing device 110 and processor 112 to a network 120. Network interface 118 may include one or more network interface cards, network interface chips, and/or the like providing support for at least the low-level connectivity to network 120, such as by providing the network access functionality for one or more network types under the TCP/IP protocol and/or the physical and data link layers of the OSI networking model for the one more network types. In some examples, the one or more network types may include wired, fiber optic, and/or wireless network types including Ethernets, fibre channels, and/or the like.

Network 120 may include any type of network, network equipment, and/or the like. In some examples, network 120 may include one or more switches, routers, hubs, gateways, and/or the like. In some examples, network 120 may include one or more local area networks (LANs) (e.g., an Ethernet), one or more wide area networks (e.g., the Internet), and/or the like.

Also shown in FIG. 1 is target device 130. Target device 130 includes examples of representative features and characteristics that may be typical of the target devices within the computing infrastructure that is being monitored by security module 116. For example, target device 130 is shown with a network interface 132 coupling target device 130 to network 120, a processor 134 coupled to network interface 132, and a memory 136 coupled to processor 134. In some examples, network interface 132, processor 134, and memory 136 may be substantially similar to network interface 118, processor 112, and memory 114, respectively. And although target device 130 is shown as a stand-alone computing device, target device 130 may also be representative of a board added to another computing device, and/or as a virtual machine. Target device 130 is further associated with a network address, such as an IP address (e.g., an IPv4 or an IPV6 address).

Memory 136 is also shown with one or more services 138. Each of the one or more services 138 is configured to listen to a respective one or more logical ports of target device 130 so that service 138 receives incoming network traffic addressed to the respective one or more logical ports associated with service 138 and generates outgoing network traffic on the respective one or more logical ports that are responsive to the incoming network traffic that was received. In this way, each of the one or more services 138 is able to receive and respond to communications and/or service requests from other computing devices coupled to target device 130 via network 120. As but a few of many possible examples, each of the one or more services 138 may correspond to a File Transfer Protocol (FTP) service, a Telnet service, a Simple Mail Transfer Protocol (SMTP) service, a Post Office Protocol (POP) service, an Internet Message Access Protocol (IMAP) service, a Hypertext Transfer Protocol (HTTP) service, a Hypertext Transfer Protocol Secure (HTTPS) service a Remote Desktop Protocol (RDP) service, a database access service, a Secure Shell (SSH) service, a Server Message Block Protocol (SMB) service, and/or the like. In addition, because at least one of the one or more services 138 is listening and responding to network traffic addressed to the respective one or more logical ports, the respective one or more logical ports are considered to be open. In some examples, the respective one or more logical ports may correspond to any of the 65,536 UDP or TCP ports typically used with network connected target devices like target device 130. And although the one or more services 138 are characterized as a software module, each of the one or more services 138 may be implemented using software, hardware, and/or a combination of hardware and software.

When there are a large number of target devices like target device 130, security module 116 may not be able to handle all of the monitoring tasks by itself. In some examples, security module 116 may assign one or more tasks to one or more agent devices, which may correspond to cloud computing devices. FIG. 1 shows an agent device 140, which may be representative of any of the one or more agent devices usable by security module 116.

As shown, agent device 140 includes examples of representative features and characteristics that may be typical of the agent devices to which security module 116 assigns one or more tasks. For example, agent device 140 is shown with a network interface 142 coupling agent device 140 to network 120, a processor 144 coupled to network interface 142, and a memory 146 coupled to processor 144. In some examples, network interface 142, processor 144, and memory 146 may be substantially similar to network interface 118, processor 112, and memory 114, respectively. And although agent device 140 is shown as a stand-alone computing device, agent device 140 may also be representative of a board added to another computing device, and/or as a virtual machine.

Memory 146 is also shown with various services that security module 116 may assign the one or more tasks to. More specifically, agent device 140 and memory 146 are shown with one or more evaluation services 150 and one or more validation services 160. However, in other embodiments, an agent device may include only one evaluation service 150, one validation service 160, only one or more evaluation services 150, only one or more validation services 160, and/or any combination thereof.

Each of the one or more evaluation services 150 communicates with security module 116 and is assigned one or more evaluation tasks to perform. In some examples, the one or more evaluation tasks may include scanning the ports of one or more target devices to see which ports are open, discovering hosts, vulnerability scanning, and/or the like. Examples of tools and/or services that can perform port scanning include massscan, scanrand, unicornscan, ZMap, nmap, Tenable, Qualys, custom-built tools, and/or the like. Examples of tools and/or services that can perform host discovery include nmap, Tenable, Qualys, custom-built tools, and/or the like. Examples of tools and/or services that can perform vulnerability scanning include Tenable, Qualys, custom-built tools, and/or the like. Further examples of one or more evaluation services 150 are described in commonly-owned U.S. patent application Ser. No. 16/714,649, filed Dec. 13, 2019, and disclosing “Techniques for Analyzing Network Vulnerabilities,” which is incorporated by reference herein.

In some examples, each of the one or more evaluation services 150 may perform an evaluation periodically (e.g., every six hours, every twelve hours, every day, every week, and/or the like), on demand from security module 116, and/or continuously.

Each of the one or more validation services 160 communicates with security module 116 and is assigned one or more validation tasks to perform. In some examples, the one or more validation tasks may include examining the results from one or more of the evaluation services 150 to either confirm (e.g., validate) or rule out an issue and/or vulnerability detected by one or more of the evaluation services 150. In some examples, the one or more validation tasks may include attempting to exploit a vulnerability detected by one or more of the evaluation services 150 to validate whether the corresponding target device may be compromised using the vulnerability.

As discussed above and further emphasized here, FIG. 1 is merely an example which should not unduly limit the scope of the claims. One of ordinary skill in the art would recognize many variations, alternatives, and modifications. According to some embodiments, the distribution of security module 116, the one or more services 138, the one or more evaluation services 150, and/or the one or more validation services 160 may be arranged among computing device 110, target device 130, and/or agent device 140 in different ways than as expressly depicted in FIG. 1. For example, one or more of the one or more the one or more vulnerability services 150 and/or the one or more validation services 160 may be located on computing device 110 and/or target device 130. As another example, security module 116 may be located on target device 130 and/or agent device 140. As yet another example, computing device 110 and/or agent device 140 may also be a target device so that the one or more services 138 may be located on computing device 110 and/or agent device 140.

### Security Module for Monitoring a Computing Infrastructure

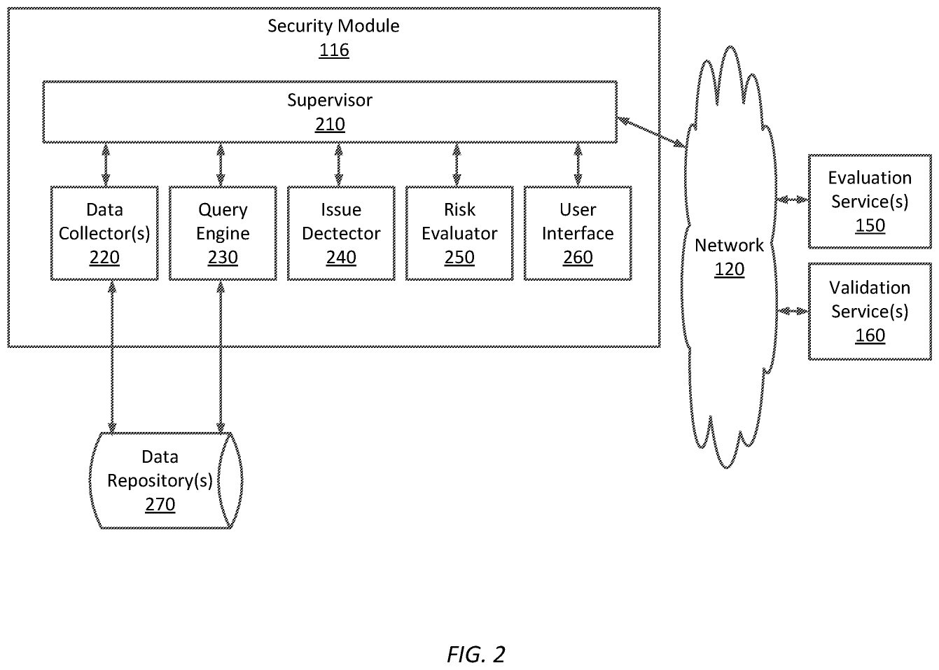

FIG. 2 is a more detailed illustration of security module 116 to implement one or more aspects of the various embodiments. As shown, security module 116 includes a supervisor 210, one or more data collectors 220, a query engine 230, an issue detector 240, a risk evaluator 250, and a user interface 260. Supervisor 210 is responsible for managing and coordinating the monitoring activities of security module 116. Supervisor 210 further oversees and manages the activities of the one or more data collectors 220, query engine 230, issue detector 240, risk evaluator 250, and user interface 260. In more detail, supervisor 210 is responsible for one or more of identifying one or more target devices 130 to be evaluated, using the one or more evaluation services 150 to scan and/or evaluate each of the one or more target devices 130, employing the one or more data collectors 220 to extract evaluation results from the responses provided by the one or more evaluation services 150 and/or the one or more validation services 160, using query engine 230 to perform one or more queries on the information extracted by the one or more data collectors 220, using issue detector 240 to determine whether the information extracted by the one or more data collectors 220 indicates that a target device has an issue and/or a vulnerability of interest, using risk evaluator 250 to determine whether use of one of the validation services 160 on a target device should proceed, and/or presenting information to one or more users via user interface 260. The functions and actions of supervisor 210 and security module 116 are described in further detail below.

Because each of the one or more evaluation services 150 and/or the one or more validation services 160 may evaluate target devices 130 for different issues and/or vulnerabilities and/or provide evaluation results in a different way, it is often challenging to extract, consolidate, cross-reference, and/or the like the evaluation results. For example, some of the one or more evaluation services 150 and/or the one or more validation services 160 may provide results in one or more of a text or flat-file format, a structured text format (e.g., eXtensible Markup Language (XML)), a user interface that may be scraped, an application programming interface (API) that may return results, a query engine for responding to queries, and/or the like. In addition, because each of the one or more evaluation services 150 may use different evaluation techniques and/or be hosted on a different agent device 140, it is possible that different evaluation services 150 may provide different conclusions as to whether a particular target device 130 has a particular issue and/or a particular vulnerability. For example, two different evaluation services 150 may provide different results as to how many ports on a particular target device 130 are open, whether the particular target device 130 is vulnerable to a particular exploit, and/or the like.

To help address this, supervisor 210 makes use of different ones of the one or more data collectors 220 for each of the one or more evaluation services 150 and/or the one or more validation services 160. In some examples, each of the one or more evaluation services 150, each type of the one or more evaluation services 150, each of the one or more validation services 160, and/or each type of the one or more validation services 160 may have a specific data collector 220 that understands what types of evaluation results a corresponding evaluation service 150 provides and/or what type of validation results a corresponding validation service 160 provides and how to extract the evaluation and/or validation results by performing extraction tasks. In some examples, the extraction tasks may include one or more of text parsing, keyword matching, calling of API functions, making queries, and/or the like. In some examples, the extraction tasks convert the evaluation and/or validation results from the format and/or labeling of the one or more evaluation services 150 and/or the one or more validation services 160 and converts them to a common format and/or labeling that facilitates later querying, comparing, cross-referencing, and/or the like of the extraction and/or validation results received from different evaluation services 150 and/or validation services 160.

In some examples, each of the one or more data collectors 220 may additionally store the extracted evaluation results and/or validation results in one or more data repositories 270, such as one or more files, one or more data structures, one or more databases, and/or the like. And although the one or more data repositories 270 are depicted as being outside of security module 116, each of the one or more data repositories 270 may be part of security module 116 and/or located in computing device 110, in one or more of the target devices 130, in one or more of the agent devices 140, and/or in any other computing device local and/or remote to computing device 110.

Supervisor 210 uses query engine 230 to make one or more queries on the evaluation and/or validation results and/or other data stored in the one or more data repositories. In some examples, the one or more queries may be written in a query language, such as structured query language (SQL). In some examples, the one or more queries may include predefined queries, parameterized queries with one or more parameters, and/or one or more custom queries written by a user. In some examples, the one or more parameters may be input via user interface 260 and/or received by security module 116 using one or more API functions of security module 116.

Supervisor 210 uses issue detector 240 to determine whether a particular target device 130 may have one or more issues and/or vulnerabilities that may be of interest. In some examples, supervisor 210 may provide data and/or other information on the particular target device 130 from the one or more data repositories 270 to issue detector 240. Issue detector 240 may include one or more scripts, one or more rule bases, and/or one or more pattern detection modules that look for certain characteristics and/or patterns in the data and/or other information that may indicate the presence of potential issues and/or vulnerabilities. In some examples, different scripts, rule bases, and/or pattern detection modules may be used to detect different potential issues and/or vulnerabilities. In some examples, the one or more pattern detection modules may include one or more machine learning modules (e.g., one or more neural networks) and/or the like. In some examples, the one or more machine learning modules may be trained based on previously collected data and/or information along with ground truth values for whether corresponding target devices 130 have particular issues and/or vulnerabilities. In some examples, issue detector 240 may further determine a confidence score as to the likelihood that the particular target device 130 has the particular issue and/or vulnerability. In some examples, the data and/or other information may include one or more of an address (e.g., an IP address or a MAC address) of the particular target device 130, a type of operating system and/or other software running on the particular target device 130, a version of the operating system and/or the other software, a list of open ports, a memory utilization, a processor utilization, a type of one of the services 138 listening on a port, a version of the service 138, and/or the like. As a non-limiting example, issue detector 240 may identify a potential issue and/or vulnerability when a specific version of a specific type of service 138 (e.g., a web server) that is known to have potential issues and/or vulnerabilities. As another non-limiting example, issue detector 240 may identify a potential issue and/or vulnerability when a specific pattern of open ports is detected on a target device 130 based on a list of open ports provided by one or more evaluation services 150. As yet another non-limiting example, issue detector 240 may help identify a potential issue and/or vulnerability even when two or more of evaluation services 150 provide conflicting evidence of whether the potential issue and/or vulnerability is present (e.g., the one or more evaluation services 150 may provide different lists of open and closed ports for a target device 130).

When issue detector 240 reports a potential issue and/or vulnerability to supervisor 210, supervisor 210 may use one or more rules and/or decision modules to determine whether validation to confirm whether the potential issue and/or vulnerability is present is to be performed. In some examples, the one or more rules and/or decision modules may make the decision on whether to validate the potential issue and/or vulnerability based on a type of the issue and/or vulnerability, a risk level associated with the issue and/or vulnerability, the confidence score in the determination made by issue detector 240, a time and/or computing cost associated with the validation, an availability of a particular validation service 160 to perform the validation, and/or the like. In addition, because some of validation services 160 validate the presence of an issue and/or a vulnerability by attempting to exploit the vulnerability, this may expose the corresponding target device 130 to a risk of service loss (e.g., a failure in the service 138 being exploited by the validation service 160), down time in the service 138 and/or other portions of the corresponding target device 130), and/or the like. Thus, in some cases, supervisor 210 may use a risk evaluation process before having the validation service 160 attempt to exploit the potential issue and/or vulnerability. In some examples, the risk evaluation process may use different scripts, subroutines, functions, and/or modules to perform the risk evaluation process for different types of potential issues and/or vulnerabilities.

In some examples, the risk evaluation process may include collecting profile metrics for the service 138 and/or the corresponding target device 130. In some examples, the profile metrics may include one or more of a type of service 138, a version of service 138, a type of operating system on the corresponding target device 130, a version of the operating system, a memory capacity of the corresponding target device 130, a memory utilization of the corresponding target device 130, a CPU utilization of the corresponding target device 130, a type of hardware used in the corresponding target device 130, whether the corresponding target device 130 is a virtual device, a cloud service provider for the corresponding target device 130, and/or the like. In some examples, the risk evaluation process may further base the decision on whether to proceed with the validation using the validation service 160 based on the confidence score provided to supervisor 210 by issue detector 240 for the potential issue and/or vulnerability. In some examples, the collected profile metrics, the type of the potential issue and/or vulnerability, and/or the confidence score may then be passed to risk evaluator 250 to determine whether validation of the potential issue and/or vulnerability should be performed.

Risk evaluator 250 may include one or more scripts, one or more rule bases, and/or one or more pattern detection modules that look for certain characteristics and/or patterns in the profile metrics, confidence scores, and/or types of issues and/or vulnerabilities to perform the risk evaluation. In some examples, different scripts, rule bases, and/or pattern detection modules may be used to evaluate the risk associated with different potential issues and/or vulnerabilities. In some examples, the one or more pattern detection modules may include one or more machine learning modules (e.g., one or more neural networks) and/or the like. In some examples, the one or more machine learning modules may be trained based on previously collected profile metrics, confidence scores, and/or types of issues and/or vulnerabilities along with ground truth values as to whether validation attempts by validation services 160 are likely to cause loss of service, down time, and/or the like. In some examples, the validation results from the validation services may be processed by the one or more data collectors 220 to extract and store relevant information about the validations.

Supervisor 210 further makes use of user interface 260 to provide and/or solicit information from one or more users. In some examples, user interface 260 may provide the evaluation results received from any of the evaluation services 150, subsets of the evaluation results, aggregations of evaluation results received from different evaluation services 150, indicators and/or other alerts associated with potential issues and/or vulnerabilities detected, results of queries such as those performed by query engine 230, trend analyses over time, results received from issue detector 240, results received from the risk evaluation process, validation results received from the validation services 160, custom user queries, and/or the like. In some examples, the subset of the evaluation results may be focused on a specific analysis, a type of issue, a type of vulnerability, and/or the like.

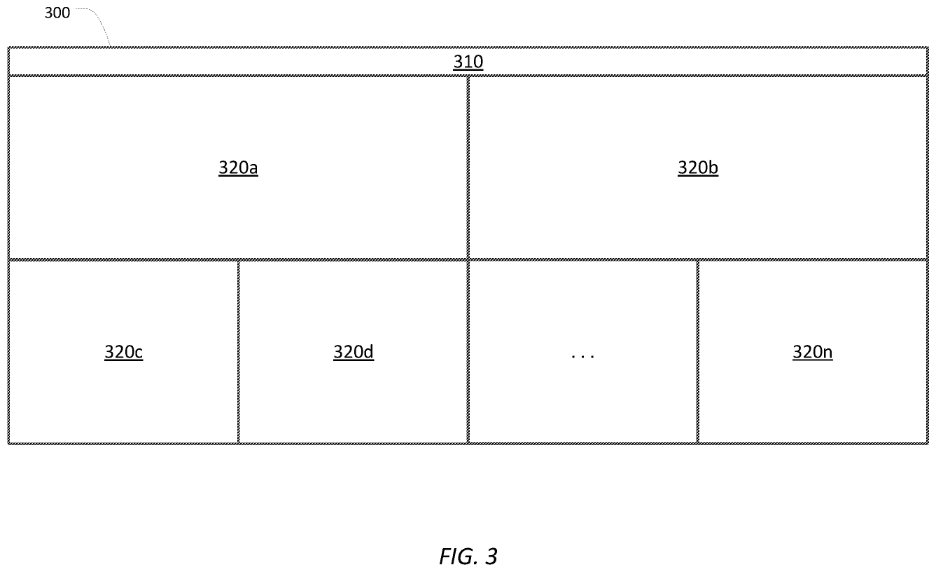

FIG. 3 illustrates an example user interface 300 for security module 116 to implement one or more aspects of the various embodiments. In some embodiments, user interface 300 may be used as part of user interface 260. As shown in FIG. 3, user interface 300 includes a navigation bar 310 and a plurality of user interface tiles 320(a)-(n) (collectively referred to as user interface tiles 320). In some examples, navigation bar 310 may include one or more menus, one or more tabs, and/or any other user interface mechanism for selecting different content to display in each of the user interface tiles 320. Each of the user interface tiles 320 may be used to display and/or solicit different information from a user. In some examples, each of the user interface tiles may include a title and/or some other type of identifying information to provide the user with context information in the respective user interface tile 320. One non-limiting example of a user interface tile 320 is a parameter entry tile that may be used to solicit parameters for one or more parameterized queries. Examples of parameters may include one or more of an address, a range of addresses, a port number, a range of port numbers, a time period (e.g., start and/or end times), a desired granularity (e.g., by minute, by hour, by day, etc.), and/or the like. Another non-limiting example of a user interface tile 320 is a custom query tile where the user may draft a query to be send to a query engine, such as query engine 230. Yet another non-limiting example of a user interface tile 320 is a plot over time of desired information. Examples of this include a number of issues and/or vulnerabilities detected, a number of open ports detected, a number of hosts/addresses detected, and/or the like. In some examples, multiple plots may be included in the user interface tile that may breakdown the displayed results, such as different plots of a number of issues and/or vulnerabilities over time for each of different types of issues and/or vulnerabilities. Yet another non-limiting example of a user interface tile 320 includes a results tile to display the results of one or more queries, the results received from an evaluation service 150 and/or a validation service 160, and/or the like. Yet another non-limiting example of a user interface tile 320 is an alert tile to provide notices to the users of the presence of issues and/or vulnerabilities, high risk issues and/or vulnerabilities, alerts for user intervention (e.g., when the risk evaluation process determines there is too much risk to perform a validation with an optional input to allow the user to override the determination), and/or the like.

In some embodiments, two or more of the user interface tiles 320 may provide information on different facets of a same general issue. As a non-limiting example, user interface tile 320(a) may be used as a parameter input tile to provide parameters related to a number of open ports, such as a range of port numbers, a time range, a granularity, and/or the like. User interface tile 320(b) may show the results of the parameterized query for the number of open ports and user interface tiles 320(c)-(n) may show the number of open ports determined from the evaluation results received from different evaluation services 150. As another non-limiting example, user interface tile 320(a) may provide overall information on monitoring being performed by security module 116. The overall information may include one or more of a number of target devices 130 being monitored, a monitoring rate (e.g., a rate of evaluations by the one or more evaluation services 150 being performed over a time interval, a rate of validations, and/or the like), and/or the like. User interface tile 320(b) may provide a running log of evaluations and/or validations being requested and/or completed, and/or the like. User interface tiles 320(c)-(n) may be used as reporting tiles for individual evaluations and/or validations, reports on recently detected and/or confirmed issues and/or vulnerabilities, time plots, and/or the like.

It is further understood that user interface 300 is non-limiting and that other arrangements and/or user interfaces 300 may be used as part of user interface 260. For example, user interfaces with interface tiles of different relative sizes and/or interface tiles of a uniform size are possible. Additionally and/or alternatively, interface tiles using non-rectangular and/or non-grid layouts are possible as well as user interfaces with fewer and/or more user interface tiles, fewer or more interface tiles in a row of interface tiles, fewer or more rows of interface tiles, interface tiles of different relative sizes, interface tiles of all the same size, and/or the like than as depicted in FIG. 3.

### Monitoring a Computing Infrastructure

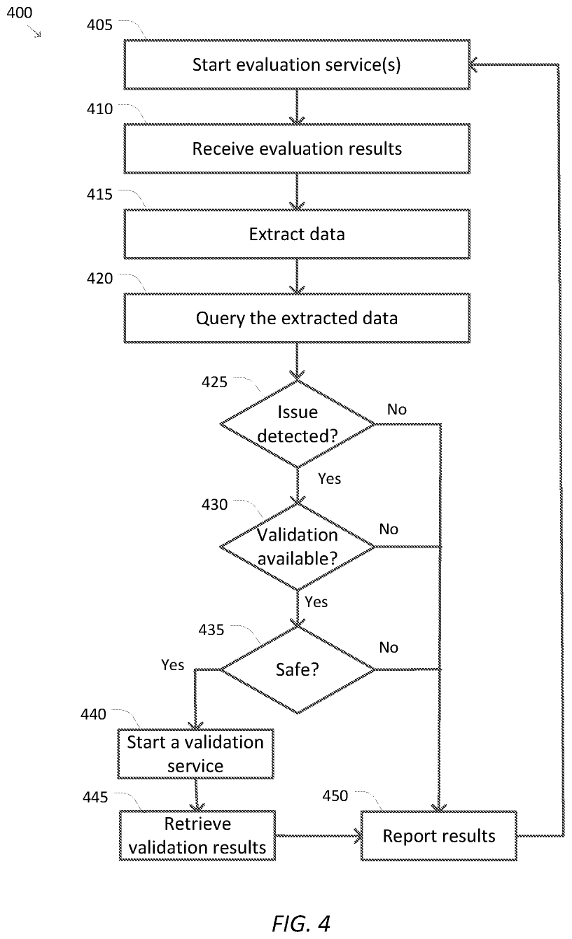

FIG. 4 sets forth a flow diagram of method steps of a method 400 for monitoring computing devices for issues and/or vulnerabilities to implement one or more aspects of the various embodiments. One or more of the steps of FIG. 4 may be implemented, at least in part, in the form of executable code stored in one or more non-transitory, tangible, computer-readable storage media that when run by one or more processors (e.g., processor 112 in computing device 110) may cause the one or more processors to perform one or more of the steps. In some embodiments, the steps of FIG. 4 may be performed by one or more modules, such as security module 116, supervisor 210, the one or more data collectors 220, query engine 230, issue detector 240, risk evaluator 250, and/or user interface 260. In some embodiments, the steps of FIG. 4 may be used to perform evaluations on a plurality of target devices 130 using one or more evaluation services 150, extract results from those evaluations, determine whether one or more issues or vulnerabilities are present on the target devices 130, and perform one or more actions to validate and/or confirm whether the one or more issues or vulnerabilities are present. Although the steps of FIG. 4 are described with reference to the embodiments of FIGS. 1, 2 and 3, persons skilled in the art will understand that any system configured to implement the steps of FIG. 4, in any order, falls within the scope of the embodiments. For example, the embodiments of FIG. 4 may be adapted to other arrangements of computing devices, functional blocks and modules, and/or the like.

At a step 405, one or more evaluation services 150 are started. In some examples, security module 116 and/or supervisor 210 determines which of the one or more evaluation services 150 to start. In some examples, each of the one or more evaluation services 150 are started by sending an evaluation command, calling an API function, invoking a remote procedure call, and/or the like to the respective evaluation service 150. Once started, each of the one or more evaluation services 150 is directed to perform an evaluation of a specified target device 130 from among a plurality of target devices to determine properties of the specified target device 130 and/or to identify factors that may indicate whether the specified target device 130 may have one or more issues and/or one or more vulnerabilities. In some examples, the one or more evaluation services 150 may be started based on any of a plan of regular and/or systematic evaluation of the plurality of target devices 130, on demand from one or more users, based on the results extracted from previously performed evaluations of the plurality of target devices. In some examples, multiple evaluation services 150 may be started to evaluate a same target device 130 either serially, concurrently, and/or some combination of both. In some examples, an evaluation service 150 may evaluate multiple target devices 130 either serially, concurrently, and/or some combination of both. In some examples, each of the one or more evaluation services 150 may perform one or more evaluation tasks, which may include scanning the ports of one or more target devices to see which ports are open, discovering hosts, vulnerability scanning, and/or the like.

At a step 410, evaluation results are received. As each one of the one or more evaluation services 150 completes part of all of its evaluation, the evaluation results from the evaluation service 150 are returned to security module 116 and/or made available to security module 116. In some examples, the evaluation results may be received in one or more of a text or flat-file format, a structured text format (e.g., XML), and/or the like. In some examples, the evaluation results may be accessible using one or more of a user interface that may be scraped, an application programming interface (API) that may return evaluation results, a query engine for responding to queries, and/or the like. In some examples, the evaluation results may be received as a response to the evaluation command, the API call, the remote procedure call, and/or the like used to start the respective evaluation service 150. In some examples, the respective evaluation service 150 may notify security module 116 that evaluation results are available. In response to receiving the evaluation results and/or the notification that evaluation results are available, security module 116 passes the results to a respective data collector 220 that is able to extract data of interest from the respective evaluation service.

At a step 415, data is extracted from the evaluation results using the one or more data collectors 220. In some examples, the data collector 220 selected to extract the data from the evaluation results may be selected based on a type of the respective evaluation service that returned the evaluation results during step 410. In some examples, the data may be extracted from the evaluation results using one or more extraction tasks. In some examples, each of the extraction tasks may include one or more of text parsing, keyword matching, calling of API functions, making queries, and/or the like. In some examples, the data collector 220 may store the extracted data in the one or more data repositories 270.

At a step 420, the extracted data is queried. In some examples, supervisor 210 may select one or more queries to execute against the extracted data based on one or more of a type of evaluation results received during step 410, a type of monitoring and/or evaluation being monitored by supervisor 210, a type of issue and/or vulnerability being tested for by security module 116, and/or the like. In some examples, supervisor 210 may provide one or more queries to query engine 230 to selectively retrieve portions of the extracted data from the one or more data repositories.

At a step 425, it is determined whether the extracted data indicates that an issue and/or a vulnerability has been detected. In some examples, the issue and/or the vulnerability may be detected directly from the results of one or more of the queries performed during step 420. In some examples, issue detector 240 may be used to determine whether an issue and/or a vulnerability is detected. In some examples, an issue and/or a vulnerability is detected when a confidence score associated with the detection is above a confidence threshold. In some examples, when the extracted data from evaluation results from two or more evaluation services 150 disagree as to whether an issue and/or a vulnerability exists, the conflict may be resolved based on which detection has a highest confidence store, a weighted or unweighted sum of the confidence scores being above the confidence threshold, the structure of the query, the conflict resolution properties of issue detector 240, and/or the like. When an issue and/or a vulnerability is detected, the issue and/or the vulnerability is further processed beginning with a step 430. When an issue and/or a vulnerability is not detected, the results of the evaluation are reported by a step 450.

At step 430, it is determined whether a validation service 160 is available to validate and/or otherwise confirm that the issue and/or vulnerability is present. In some examples, certain types of issues and/or vulnerabilities are not able to be validated and no validation service 160 for those issues and/or vulnerabilities exists. In these cases, detection of the issue and/or the vulnerability is determined based on the results of step 425. In some examples, a corresponding validation service 160 exists for the issue and/or the vulnerability, but the corresponding validation service 160 is not available for use (e.g., because a corresponding agent device 140 is down and/or unreachable, an execution limit has been reached, and/or the like). When a validation service 160 is not available, the determination that the issue and/or the vulnerability as detected during step 425 is reported using step 450. When a validation service 160 is available, the issue and/or the vulnerability are further processed beginning with a step 435.

At step 435, it is determined whether it is safe to proceed with validation of the issue and/or the vulnerability using an appropriate validation service 160. In some examples, the appropriate validation service 160 may be identified and/or selected based on a type of the issue and/or the vulnerability detected during step 425. In some examples, risk evaluator 250 may be used to determine whether the risk level in performing the validation using the appropriate validation service 160 is below an acceptable risk threshold so that it is safe to proceed with the validation.

In some examples, risk evaluator 250 may evaluate the risk of failure and/or downtime in a target device 130 should the appropriate validation service 160 be successful in exploiting the issue and/or the vulnerability. In some examples, when step 435 determines that it is not safe to proceed e.g., the risk is too high), this may be reported to a user who may elect to override the risk and have the validation performed despite the risk. When it is not safe to proceed, the determination that the issue and/or the vulnerability as detected during step 425 along with an indication that there was too much risk to automatically proceed with the validation are reported using step 450. When it is safe to proceed with the validation, the validation is performed beginning with a step 440.

At step 440, the appropriate validation service 160 is started. In some examples, the appropriate validation service 160 may be started using techniques similar to those used during step 405 to start one of the evaluation services 150.

At a step 445, the results of the validation are retrieved. In some examples, the results of the validation may be retrieved using techniques similar to those used during steps 410, 415, and/or 420 to receive, extract, and query data in the evaluation results. The results of the validation that confirm and/or refute the presence of the issue and/or the vulnerability are then reported using step 450.

At step 450, the results generated by steps 425, 430, 435, and/or 445 are reported. In some examples, the results may include information that identifies one or more of the issue and/or the service detected or not detected, the target device 130, the software (including a version number, if applicable) and/or the hardware associated with the issue and/or the vulnerability, a port number associated with the issue and/or the vulnerability, and/or the like. As a non-limiting example, the results may indicate that target device 130 with address XYZ has a version of service ABC with version number N that is vulnerable to a DEF exploit and is accessible on open port M. As another non-limiting example, the results may indicate that target device with address XYZ does not have any detected issues and/or vulnerabilities. As yet another non-limiting example, the results may indicate that target device 130 with address XYZ has a version of service ABC with version number N that is vulnerable to a DEF exploit and is accessible on open port M, but has not been validated due to a risk level of doing so. In some examples, the results may be reported by sending an alert (e.g., a text message, an email, a push notification, and/or the like) to one or more users, one or more services, and/or the like. In some examples, the results may be reported by displaying the results using user interface 260 and/or 300. In some examples, the results may also be stored in the one or more data repositories 270. After the results are reported, method 400 repeats by returning to step 405.

As discussed above and further emphasized here, FIG. 4 is merely an example which should not unduly limit the scope of the claims. One of ordinary skill in the art would recognize many variations, alternatives, and modifications. According to some embodiments, the order and/or arrangements between the steps of method 400 may be different than as implied by the flow chart of FIG. 4. In some examples, steps 405, 410, and 415 may be performed asynchronously. In some examples, step 405 may be used to start the one or more evaluation services 150 without waiting for them to complete before starting additional evaluation services 150. In some examples, step 410 is initiated when evaluation results are received from one of the evaluation services 150 started by process 405. In some examples, once the evaluation results are received step 415 may automatically extract the data of interest. In some examples, step 405 may be performed in a different process or thread than steps 410 and 415.

In some embodiments, steps 405, 410, and 415 may be performed in a first loop that is independent of a second loop used to perform steps 420, 425, 430, 435, 440, 445, and 450. In some examples, the starting of evaluation services 150 and the extraction of data from their results may continue independent of the remaining steps of method 400 used to detect and validate any issues and/or vulnerabilities that may be determined from the evaluation results. In some examples, these loops may be performed in different processes and/or threads.

In some embodiments, steps 410, 415, 420, and 425 may be performed in a first loop that is independent of steps 430, 435, 440, 445, and 450. In some examples, when evaluation results are received from an evaluation service 150, data may be extracted from the evaluation results and then various queries on the extracted data are performed so that this issue and/or vulnerability detection of step 425 may then be used to find each of the potential issues and/or vulnerabilities in the evaluation results. In some examples, each of the potential issues and/or vulnerabilities may be placed in a queue where they may each be removed from the queue and then processed in turn by steps 430, 435, 440, 445, and 450. In some examples, these loops may be performed in different processes and/or threads.

In some embodiments, step 430 may optionally place the potential issue and/or vulnerability in a queue for later validation when no appropriate validation service 160 is currently available. In some examples, when an appropriate validation service 160 becomes available, the potential issue and/or vulnerability may be removed from the queue and then processed by step 435.

In some embodiments, the risk evaluation of step 435 may be performed multiple separate times when more than one type of appropriate validation service 160 is available to validate the potential issue and/or vulnerability. In some examples, a different risk evaluation may be performed for each of the appropriate validation services 160 based on the different risks that are possible for each of the appropriate validation services 160. In some examples, one appropriate validation service 160 may be considered too risky while a second appropriate validation service 160 may be considered safe enough to proceed. In some examples, the appropriate validation service 160 to use to validate the potential issue or vulnerability is selected based on which type of the appropriate validation services 160 is evaluated to have a lowest risk.

In some embodiments, a combination of steps 420 and 450 may be used to support use of user interfaces 260 and/or 300 by one or more users. In some examples, the one or more users may use user interfaces 260 and/or 300 to select an analysis to be performed on the extracted data stored in the one or more data repositories 270. Depending on the selected analysis, one or more queries are executed against the queried data to display the results of the analysis requested by the one or more users.

In sum, the disclosed techniques may be used to efficiently and comprehensively analyze a plurality of target devices for one or more issues and/or vulnerabilities. In one embodiment, a security module includes, without limitation, a supervisor module, one or more data collectors, a query engine, an issue detector, a risk evaluator, and a user interface. The supervisor module first starts one or more evaluation services that evaluate the plurality of target devices. The evaluation results are then examined by the one or more data collectors to extract data of interest, which is then stored in one or more data repositories. The extracted data is then queried using the query engine to retrieve data that may be indicative of one or more issues and/or vulnerabilities present in the plurality of target devices. The retrieved data is then processed by the issue detector to detect whether one or more potential issues and/or vulnerabilities are present. When a validation service is available to validate and/or confirm the presence of one of the potential issues and/or vulnerabilities, the risk evaluator is used to determine whether it is safe to proceed with the validation before starting an appropriate validation service to perform the validation. The results of the evaluation may optionally be displayed using the user interface.

At least one technical advantage of the disclosed techniques relative to the prior art is that the disclosed techniques provide automated mechanisms to integrate and consolidate the evaluation results of multiple target devices received from multiple evaluation services that each provide evaluation results in different formats. In addition, the disclosed techniques allow the evaluation results of the multiple evaluation services to be presented in a unified manner. Further, the disclosed techniques also provide improved ways of validating whether one or more issues and/or vulnerabilities identified by one or more of the evaluation services are actually present in a target device so as to reduce or eliminate costly and/or time consuming maintenance and/or updates to the target device for which the one or more issues and/or vulnerabilities are not actually present. Finally, the disclosed techniques further provide automated mechanisms for prescreening target devices before attempting to validate the presence of issues and/or vulnerabilities. The prescreening identifies target devices that have a high risk of downtime or other failures that may result from performing a validation by a validation service so that unnecessary downtime of the target devices is reduced and/or avoided.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments.

1. In some embodiments, a computer-implemented method for monitoring a computing infrastructure having one or more target devices. The method includes receiving, from a plurality of evaluation services, evaluation results of one or more target devices, extracting, using a different data collector for each of the plurality of evaluation services, data from each of the evaluation results, converting the extracted data to a common format, determining whether an issue or a vulnerability is present in the one or more target devices based on the extracted and converted data, and reporting the issue or the vulnerability.

2. The computer-implemented method according to clause 1, wherein each of the plurality of evaluation services returns evaluation results in a different format.

3. The computer-implemented method according to clause 1 or clause 2, wherein determining whether the issue or the vulnerability is present includes using one or more of a script, a rule base, or a pattern detection module. The pattern detection module includes a machine learning module or a neural network, the machine learning module or the neural network being trained from previously collected data and ground truth values for whether an issue or a vulnerability is present.

4. The computer-implemented method according to any of clauses 1-3, wherein determining whether the issue or the vulnerability is present includes determining whether the issue or the vulnerability is present when a confidence score of the determining is above a confidence threshold.

5. The computer-implemented method according to any of clauses 1-4, further including, confirming whether the issue or the vulnerability is present using a validation service.

6. The computer-implemented method according to any of clauses 1-5, further including, performing a risk evaluation before using the validation service.

7. The computer-implemented method according to any of clauses 1-6, wherein the risk evaluation assesses a risk level of using the validation service on a first target device of the one or more target devices to confirm the issue or the vulnerability.

8. The computer-implemented method according to any of clauses 1-7, wherein the risk evaluation is performed using one or more of a script, a rule base, or a pattern detection module.

9. The computer-implemented method according to any of clauses 1-8, wherein the pattern detection module includes a machine learning module or a neural network, the machine learning module or the neural network being trained from previously collected data and ground truth values for risks of using the validation service on target devices.

10. The computer-implemented method according to any of clauses 1-9, further including collecting one or more profile metrics for a first target device of the one or more target devices. The risk evaluation is based on the one or more profile metrics and a type of the issue or a type of the vulnerability.

11. In some embodiments, one or more non-transitory computer-readable storage media including instructions that, when executed by one or more processors, cause the one or more processors to monitor a computing infrastructure having one or more target devices by performing steps including receiving, from a plurality of evaluation services, evaluation results of one or more computing devices, extracting data from each of the evaluation results, converting the extracted data to a common format, determining whether an issue or a vulnerability is present in the one or more computing devices based on the extracted and converted data, and reporting the issue or the vulnerability.

12. The one or more non-transitory computer-readable storage media according to clause 11, wherein each of the plurality of evaluation services returns evaluation results in a different format.

13. The one or more non-transitory computer-readable storage media according to clause 11 or clause 12, wherein determining whether the issue or the vulnerability is present includes using one or more of a script, a rule base, or a pattern detection module. The pattern detection module includes a machine learning module or a neural network, the machine learning module or the neural network being trained from previously collected data and ground truth values for whether an issue or a vulnerability is present.

14. The one or more non-transitory computer-readable storage media according to any of clauses 11-13, further including, confirming whether the issue or the vulnerability is present using a validation service.

15. The one or more non-transitory computer-readable storage media according to any of clauses 11-14, further including performing a risk evaluation of using a plurality of validation services that are able to confirm whether the issue or the vulnerability is present, selecting one of the validation services based on the risk evaluation, and confirming whether the issue or the vulnerability is present using the selected validation service.

16. In some embodiments, a computing device includes a memory and one or more processors coupled to the memory. The one or more processors are configured to receive, from a plurality of evaluation services, evaluation results of one or more target devices, extract, using a different data collector for each of the plurality of evaluation services, data from each of the evaluation results, convert the extracted data to a common format, determine whether an issue or a vulnerability is present in the one or more target devices based on the extracted and converted data, and report the issue or the vulnerability.

17. The computing device according to 16, wherein to determine whether the issue or the vulnerability is present, the one or processors are configured to use a machine learning module or a neural network, the machine learning module or the neural network being trained from previously collected data and ground truth values for whether an issue or a vulnerability is present.

18. The computing device according to clause 16 or clause 17, wherein the one or more processors are further configured to perform a risk assessment on using a validation service to confirm whether the issue or the vulnerability is present and in response to the risk assessment, use the validation service to confirm whether the issue or the vulnerability is present.

19. The computing device according to any of clauses 16-18, wherein the one or more processors are further configured to store the converted and extracted data in one or more data repositories, query the one or more data repositories using one or more queries, and display results of the one or more queries on a user interface.

20. The computing device according to any of clauses 16-19, wherein the one or more processors are further configured to receive one or more parameters for the one or more queries using the user interface.

Aspects of the present embodiments may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present disclosure may take the form of a computer program product embodied in one or more computer-readable medium(s) having computer readable program code embodied thereon.

Any combination of one or more computer-readable medium(s) may be utilized. The computer-readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, enable the implementation of the functions/acts specified in the flowchart and/or block diagram block or blocks. Such processors may be, without limitation, general purpose processors, special-purpose processors, application-specific processors, or field-programmable processors or gate arrays.

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the preceding is directed to embodiments of the present disclosure, other and further embodiments of the disclosure may be devised without departing from the basic scope thereof, and the scope thereof is determined by the claims that follow.

What is claimed is:

1. A computer-implemented method for monitoring a computing infrastructure having one or more target devices, the method comprising:
receiving, from a plurality of evaluation services, evaluation results of one or more target devices;
extracting, using a different data collector for each of the plurality of evaluation services, data from each of the evaluation results;
converting the extracted data to a common format;
determining whether an issue or a vulnerability is present in the one or more target devices based on the extracted and converted data; and
reporting the issue or the vulnerability.

2. The computer-implemented method of claim 1, wherein each of the plurality of evaluation services returns evaluation results in a different format.

3. The computer-implemented method of claim 1, wherein:
determining whether the issue or the vulnerability is present comprises using one or more of a script, a rule base, or a pattern detection module; and
the pattern detection module comprises a machine learning module or a neural network, the machine learning module or the neural network being trained from previously collected data and ground truth values for whether an issue or a vulnerability is present.

4. The computer-implemented method of claim 1, wherein determining whether the issue or the vulnerability is present comprises determining whether the issue or the vulnerability is present when a confidence score of the determining is above a confidence threshold.

5. The computer-implemented method of claim 1, further comprising, confirming whether the issue or the vulnerability is present using a validation service.

6. The computer-implemented method of claim 5, further comprising, performing a risk evaluation before using the validation service.

7. The computer-implemented method of claim 6, wherein the risk evaluation assesses a risk level of using the validation service on a first target device of the one or more target devices to confirm the issue or the vulnerability.

8. The computer-implemented method of claim 6, wherein the risk evaluation is performed using one or more of a script, a rule base, or a pattern detection module.

9. The computer-implemented method of claim 8, wherein the pattern detection module comprises a machine learning module or a neural network, the machine learning module or the neural network being trained from previously collected data and ground truth values for risks of using the validation service on target devices.

10. The computer-implemented method of claim 6, further comprising:
collecting one or more profile metrics for a first target device of the one or more target devices;
wherein the risk evaluation is based on the one or more profile metrics and a type of the issue or a type of the vulnerability.

11. One or more non-transitory computer-readable storage media including instructions that, when executed by one or more processors, cause the one or more processors to monitor a computing infrastructure having one or more target devices by performing steps comprising:
receiving, from a plurality of evaluation services, evaluation results of one or more computing devices;
extracting data from each of the evaluation results;
converting the extracted data to a common format;
determining whether an issue or a vulnerability is present in the one or more computing devices based on the extracted and converted data; and
reporting the issue or the vulnerability.

12. The one or more non-transitory computer-readable storage media of claim 11, wherein each of the plurality of evaluation services returns evaluation results in a different format.

13. The one or more non-transitory computer-readable storage media of claim 11, wherein:
determining whether the issue or the vulnerability is present comprises using one or more of a script, a rule base, or a pattern detection module; and
the pattern detection module comprises a machine learning module or a neural network, the machine learning module or the neural network being trained from previously collected data and ground truth values for whether an issue or a vulnerability is present.

14. The one or more non-transitory computer-readable storage media of claim 11, further comprising, confirming whether the issue or the vulnerability is present using a validation service.

15. The one or more non-transitory computer-readable storage media of claim 11, further comprising:
performing a risk evaluation of using a plurality of validation services that are able to confirm whether the issue or the vulnerability is present;
selecting one of the validation services based on the risk evaluation; and
confirming whether the issue or the vulnerability is present using the selected validation service.

16. A computing device, comprising:
a memory; and
one or more processors coupled to the memory;
wherein the one or more processors are configured to:
receive, from a plurality of evaluation services, evaluation results of one or more target devices;
extract, using a different data collector for each of the plurality of evaluation services, data from each of the evaluation results;
convert the extracted data to a common format;
determine whether an issue or a vulnerability is present in the one or more target devices based on the extracted and converted data; and
report the issue or the vulnerability.

17. The computing device of claim 16, wherein to determine whether the issue or the vulnerability is present, the one or processors are configured to use a machine learning module or a neural network, the machine learning module or the neural network being trained from previously collected data and ground truth values for whether an issue or a vulnerability is present.

18. The computing device of claim 16, wherein the one or more processors are further configured to:
perform a risk assessment on using a validation service to confirm whether the issue or the vulnerability is present; and
in response to the risk assessment, use the validation service to confirm whether the issue or the vulnerability is present.

19. The computing device of claim 16, wherein the one or more processors are further configured to:
store the converted and extracted data in one or more data repositories.
query the one or more data repositories using one or more queries; and
display results of the one or more queries on a user interface.

20. The computing device of claim 19, wherein the one or more processors are further configured to receive one or more parameters for the one or more queries using the user interface.
